(19) United States
(12) Patent Application Publication
(10) Pub. No.: US 2004/0189851 A1
(43) Pub. Date: Sep. 30, 2004

(54) Camera driving module using motor and sensor

(75) Inventors: Byung-Ook Son, Kyunggi-Do (KR); Myoung-Hoon Kwak, Seoul (KR); Kyoung-Soo Yang, Kyunggi-Do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/680,674

(22) Filed: Oct. 7, 2003

(30) Foreign Application Priority Data
Mar. 29, 2003 (KR) 2003-19774

(51) Int. Cl. H04N 5/225; G02B 13/16

(52) U.S. Cl. 348/335

(57) ABSTRACT

The present invention relates generally to a camera rotation drive module of a mobile terminal equipped with a camera. More particularly, the present invention relates to a camera rotation drive module of a mobile terminal equipped with a camera, which allows a user to push an external button of the mobile terminal to drive a motor and rotate the camera by the driven motor, and which senses an exact position of the camera by a sensor to stop the camera at a predetermined position.

The present invention provides a camera rotation drive module, which drives a motor through a simple manipulation of a user to rotate a lens tube of a camera unit and stops the camera at an exact position by the sensor, and an algorithm executed by the camera rotation drive module.

### FIELD OF THE INVENTION

The present invention relates generally to a camera rotation drive module of a mobile terminal equipped with a camera, and more particularly to a camera rotation drive module of a mobile terminal equipped with a camera, which allows a user to push an external button of the mobile terminal to drive a motor and rotate the camera by the driven motor, and which senses an exact position of the camera by a sensor to stop the camera at a predetermined position.

### BACKGROUND OF THE INVENTION

With the accelerating development of mobile terminals, such as mobile phones or Personal Digital Assistants (PDAs), additional functions, such as Internet communication and image transmission, as well as a typical call conversation function and a simple data transmission function, have been popularized. Recently, a plurality of mobile terminals equipped with a camera are marketed.

An externally mounted camera which is detachable and separately sold was previously used as a camera mounted on a mobile terminal. However, the externally mounted camera is inconvenient to attach and detach, and is inferior in appearance, so an internally mounted camera has been mainly used recently.

In the case of the internally mounted camera which is mounted within a casing of a mobile terminal, the disadvantage of the externally mounted camera can be solved, but there has been raised a problem of adjusting the direction of a camera lens. That is, when a camera is installed outside a mobile terminal in the case of the mobile terminal equipped with the conventional externally mounted camera, a manner of manually rotating a camera lens to adjust the aiming direction thereof has no problem. However, when a camera is embedded in a body of a mobile terminal in the case of the mobile terminal equipped with the internally mounted camera, it is impossible to perform the manual adjustment of the aiming direction of the camera lens.

FIG. 1 illustrates a folded state of a conventional folder type mobile terminal 1 equipped with an internally mounted camera 2. If a user manipulates an external button 3, a lens 9 of the camera 2 is rotated to face a direction P (forward) or its opposite direction (backward) as shown in FIG. 1.

Meanwhile, the present invention relates to a camera rotation drive module capable of controlling the rotation of a lens tube of a camera unit mounted in a mobile terminal using a motor. The present invention provides a construction and algorithm capable of driving a motor through a simple button manipulation by a user, rotating the lens tube with a lens mounted therein by the driven motor, and stopping the rotation of the lens tube at an exact position by a sensor.

Further, the present invention provides a construction and algorithm for parking the lens at a position, not exposed to the outside, to prevent the damage of the lens when the camera is not used.

In the present invention, a manner of driving the rotation of the lens tube of the camera is a manner using a motor.

In the prior art, a method using a physical stopper is used as a method of stopping a lens, which is driven by a motor to start to rotate, to allow the lens to face forward or backward.

FIGS. 2a to 2c illustrate methods of stopping the rotation of a camera lens to allow the lens to face forward or backward using a conventional physical stopper. FIG. 2a is a sectional view from P direction of the camera lens of FIG. 1 and FIGS. 2b and 2c are sectional views from Q direction of the camera lens of FIG. 1.

In FIGS. 2a to 2c, stoppers 12 fixed to a lens tube 8 of as camera and a stopper 13 fixed to an external casing 7 of the camera are arranged. Therefore, as shown in FIGS. 2c and 2d, when the camera lens faces forward and backward, the stoppers 12 fixed to the lens tube 8 and the stopper 13 fixed to the external casing 7 of the camera collide with each other, thus stopping the camera lens.

However, if the physical stopper is used in this way, the lens tube collides with the stopper to be stopped while rotating, so the force of impact is transferred to a motor. Especially, if a geared motor is used, there are problems in that the force of impact is transferred to the gear of the motor to damage the gear, and noise may be caused when the lens tube is stopped.

### SUMMARY OF THE INVENTION

Accordingly, the present invention has been made keeping in mind the above problems occurring in the prior art, and an object of the present invention is to provide a camera rotation drive module and algorithm executed by the same, which drives a motor to rotate a camera lens and stops the rotation of the camera lens by a sensor so as to rotate and stop the camera lens by the motor in a mobile terminal equipped with a camera.

Another object of the present invention is to provide a mobile terminal equipped with a camera and algorithm executed by the same, which allows a user to push an external command button to drive a motor, thus rotating a camera lens forward and backward, and which senses the position of the camera lens by a sensor, thus stopping the camera lens.

In order to accomplish the above object, the present invention provides a camera rotation drive module, comprising an external command button arranged on an external casing of a mobile terminal, a motor unit mounted in the mobile terminal and driven by allowing the external command button to be pushed to rotate a lens tube, a camera unit comprised of the lens tube, a lens, a sensor and a camera casing and mounted in the mobile terminal, and a control unit for stopping the motor unit in response to an output value of the sensor, wherein the lens is mounted on the lens tube, and the sensor is arranged at a position where the sensor can sense at least one projection formed on the lens tube when the lens is located at a predetermined position.

Further, the present invention provides a method of rotating a lens of a camera, comprising the steps of (a) assigning a flag to a memory in a mobile terminal when power of the mobile terminal is turned on, and setting a value of the flag to “0”, (b) pushing an external command button mounted on an external casing of the mobile terminal, (c) determining whether the flag value is “0” or “1”, (d) driving a motor counterclockwise after a predetermined time Δt if the flag value is “0”, while driving the motor clockwise after the time Δt if the flag value is “1”, (e) sensing at least one projection formed on a lens tube of the camera by a sensor arranged in a camera casing, (f) stopping the motor, (g) inverting the flag value, such as by setting “0” to “1” or by setting “1” to “0”, and (h) repeatedly performing steps (b) to (g) after an external command button is pushed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing an exterior shape of a typical mobile terminal equipped with a camera;

FIGS. 2a to 2c are views showing the construction for stopping the rotation of a lens tube using a conventional physical stopper;

FIGS. 3a to 3b are perspective views showing exterior shapes of mobile terminals having two external command buttons and one external command button, respectively;

FIGS. 4a and 4b are perspective views of a lens tube in the case where one sensor is used;

FIGS. 5a to 51 are views showing the construction and circuit for stopping the rotation of a camera lens tube using a push switch as the sensor;

FIGS. 6a and 6b are a circuit diagram and an output waveform diagram of a hall IC which is a non-contact type sensor, respectively;

FIGS. 7a to 7c are sectional views of the lens tube to show operations executed when the hall IC is used as the sensor;

FIGS. 8a to 8c are views showing an initializing process executed in the case where the lens faces backward when power is turned on in an embodiment using one sensor and one button;

FIG. 9 is a view showing an initialized state in the case where the lens faces forward when power is turned on in the embodiment using one sensor and one button;

FIGS. 10a and 10b are views showing an initializing process executed in the case where the lens faces upward when power is turned on in the embodiment using one sensor and one button;

FIGS. 11a to 11c are views showing an operation in which the lens faces forward and then faces backward when a user pushes an external command button in the case where one sensor is used;

FIGS. 12a to 12c are views showing an operation in which the lens faces backward and then faces forward when the user pushes an external command button in the case where one sensor is used;

FIGS. 13a and 13b are a block diagram showing the construction of a camera rotation drive module according to an embodiment of the present invention using one sensor and one button, and a flowchart of an algorithm executed thereby, respectively;

FIGS. 14a and 14b are views respectively showing a construction in which two sensors are arranged together on one side of a lens tube and a construction in which two sensors are arranged on both sides thereof, respectively, in the case where two sensors are used;

FIGS. 15a to 15c are views showing an operation in which the lens faces forward and then faces backward when the user pushes an external command button in the case where two sensors are used;

FIGS. 16a to 16c are views showing an operation in which the lens faces backward and then faces forward when the user pushes an external command button in the case where two sensors are used;

FIGS. 17a and 17b are a block diagram showing the construction of a camera rotation drive module according to another embodiment of the present invention using two sensors and one button, and a flowchart of an algorithm executed thereby, respectively;

FIGS. 18a and 18b are a block diagram showing the construction of a camera rotation drive module according to a further embodiment of the present invention using one sensor and two buttons, and a flowchart of an algorithm executed thereby, respectively;

FIGS. 19a and 19b are a block diagram showing the construction of a camera rotation drive module according to a further embodiment of the present invention using two sensors and two buttons, and a flowchart of an algorithm executed thereby, respectively;

FIG. 20 is a view showing a parking area;

FIG. 21 is a perspective view showing a lens tube and an external casing to describe a parking structure;

FIGS. 22a to 22d are views showing a parking operation when a lens faces forward in the case where one sensor is used;

FIGS. 23a to 23c are views showing a parking operation when the lens faces backward in the case where one sensor is used;

FIG. 24 is a parking algorithm executed in the case where one sensor is used;

FIG. 25 is a view defining the range of a projection angle in a parking structure;

FIG. 26 is a view defining a minimum value of the projection angle in the parking structure;

FIG. 27 is a view defining a maximum value of the projection angle in the parking structure;

FIGS. 28a and 28b are views respectively showing a construction in which two sensors are arranged on both sides of a lens tube, respectively, in the case where two sensors are used, and a construction in which two sensors are arranged together on one side thereof in the case where two sensors are used;

FIG. 29 is a view showing a parking algorithm when two sensors are arranged on both sides of the lens tube, respectively, in the case where two sensors are used; and

FIG. 30 is a view showing a parking algorithm when two sensors are arranged on one of both sides of the lens tube in the case where two sensors are used.

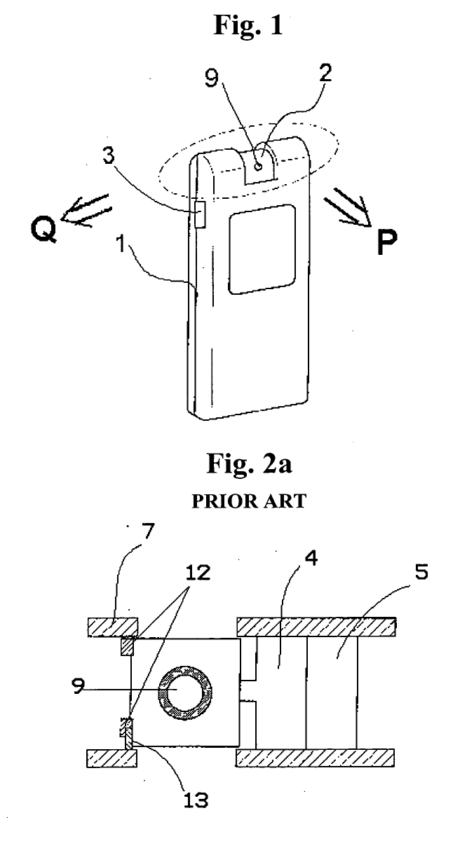

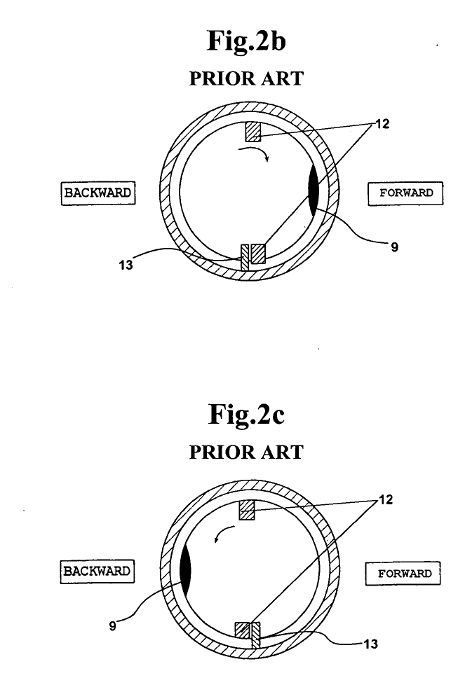

### DETAILED DESCRIPTION OF THE PREFERRED EMBODIMENT

While the preferred embodiment of the invention has been illustrated and described, it will be appreciated that various changes can be made therein without departing from the spirit and scope of the invention.

Hereinafter, embodiments of the present invention will be described in detail with reference to the attached drawings.

The present invention provides mobile terminals equipped with a camera, which comprise one sensor and one button, two sensors and one button, one sensor and two buttons, and two sensors and two buttons, respectively, and algorithms executed by them.

In the present invention, a manner of sensing the position of a lens using a sensor to stop the rotation of a lens tube is used, differently from a manner used in the prior art.

In the present specification, the same reference numerals are used throughout the different drawings to designate the same or similar components.

Hereinafter, for convenience of description, even though additional indications are not made in the drawings, it is assumed in the present invention that the same direction as a Liquid Crystal Display (LCD) panel of a mobile terminal (direction facing a user) is defined as a “forward” direction and its opposite direction is defined as a “backward” direction, and the right side of all sectional views is set to a “forward” direction and the left side thereof is set to a “backward” direction.

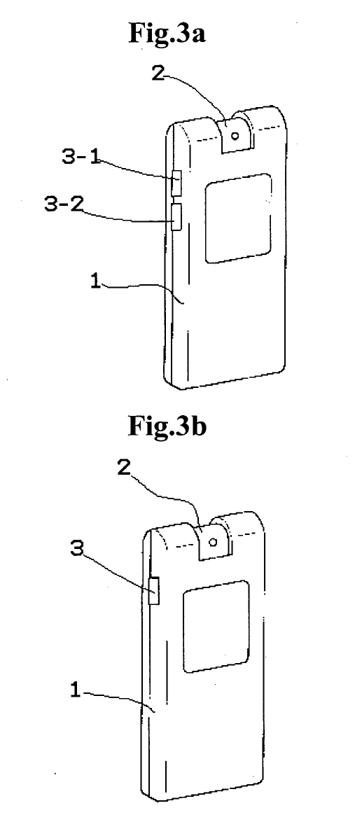

FIGS. 3a and 3b illustrate mobile terminals equipped with a camera, having two and one external command buttons 3-1,3-2,3, respectively. In the present invention, operating algorithms are varied according to the number of used sensors and external command buttons.

Hereinafter, respective cases are described in detail with reference to the drawings.

Embodiment Using One Sensor and One Button

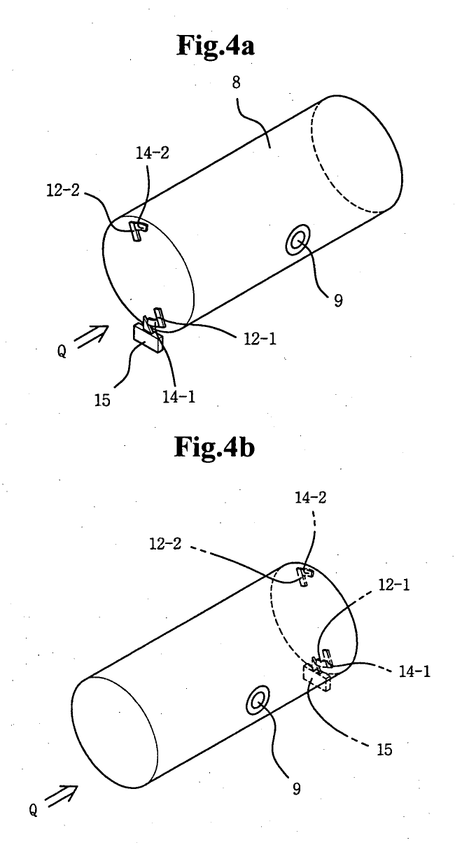

FIGS. 4a and 4b are perspective views showing the construction of a lens tube of a camera unit in the case where one sensor and one button are used. As shown in FIGS. 4a and 4b, projections and the sensor can be arranged on any of both sides a cylindrical lens tube.

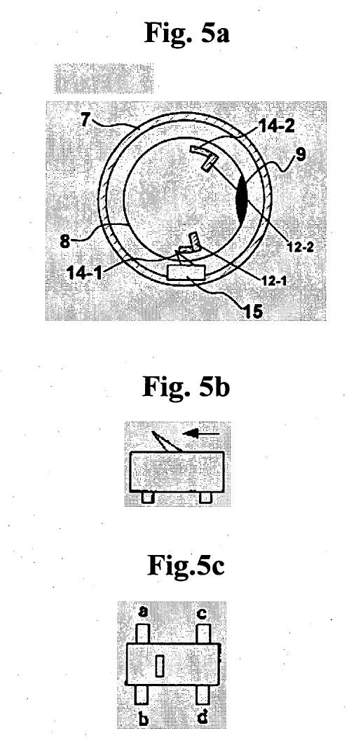

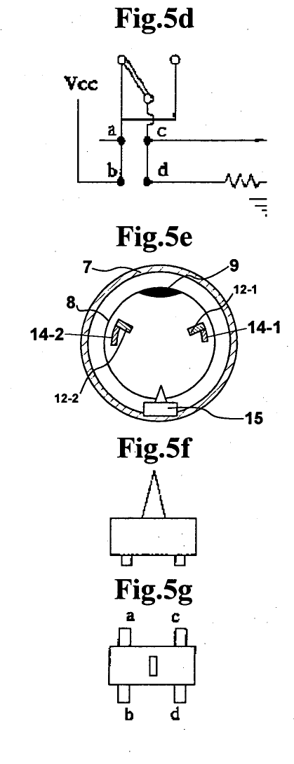

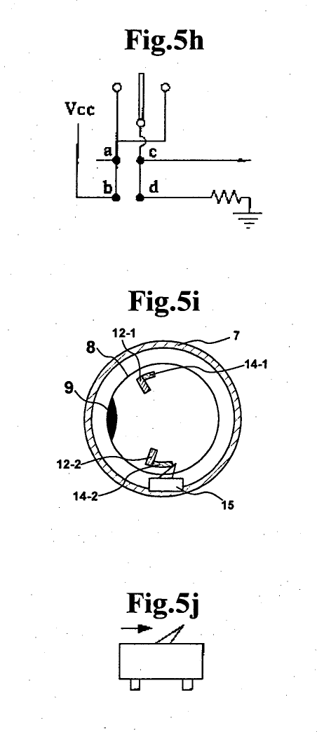

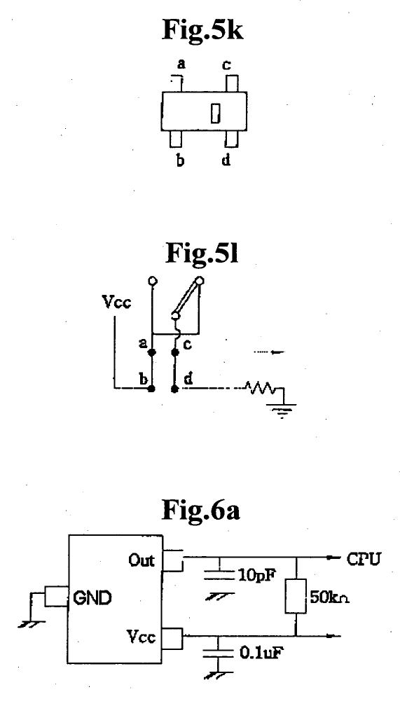

FIGS. 5a to 5l are views showing an operation when a contact type push switch is used as the sensor in the case where one sensor and one button are used.

FIGS. 5a, 5e and 5i are sectional views of the lens tube seen in the direction Q of FIGS. 4a or 4b, and show states in which a lens faces forward, rotates, and faces backward, respectively. Two projections 14-1,14-2 are formed on a lens tube 8 to push a push switch 15 according to directions which the lens faces, so that the position of the lens is sensed.

The remaining drawings (FIGS. 5b to 5d, FIGS. 5f to 5h, and FIGS. 5j to 5l) are sectional views (FIGS. 5b, 5f and 5j) of the push switch 15 in states shown in FIGS. 5a, 5e and 5i, respectively, plan views (FIGS. 5c, 5g and 5k) thereof, and circuit diagrams (FIGS. 5d, 5h and 5l) of a circuit in which the push switch 15 is connected to a control unit.

FIGS. 5e and 5h illustrate states in which the lens is rotated by the motor to move its position, and FIGS. 5i to 5l illustrate states in which the lens faces backward.

Referring to the plan views of the push switch 15 shown in FIGS. 5c, 5g and 5k, the push switch 15 has four terminals a, b, c and d. The terminals a and b are connected to a power source, the terminal c functions as an output terminal connected to a control unit, and the terminal d is grounded through a resistor R.

While the lens 9 faces forward as shown in FIG. 5a, the push switch 15 is pushed by one projection 14 of the lens tube 8, and in FIG. 5d the terminals a and b are connected to the terminals c and d, thus transmitting a high value to the control unit.

When the user pushes an external command button, the camera lens 9 starts to rotate. During the rotation of the camera lens, the push switch 15 is not pushed as shown in FIG. 5e, and the terminals a and b are not connected to the terminals c and d, thus transmitting a low value to the control unit.

When the lens 9 faces backward as shown in FIG. 5i, the push switch 15 is pushed by the other projection 14 of the lens tube 8 and in FIG. 5l the terminals a and b are connected to the terminals c and d, thus transmitting a high value again to the control unit.

If a transmitted signal value is high, the control unit stops the motor, while if it is low, the control unit drives the motor. In this manner, the camera lens can be stopped at a position where the camera lens faces forward or backward.

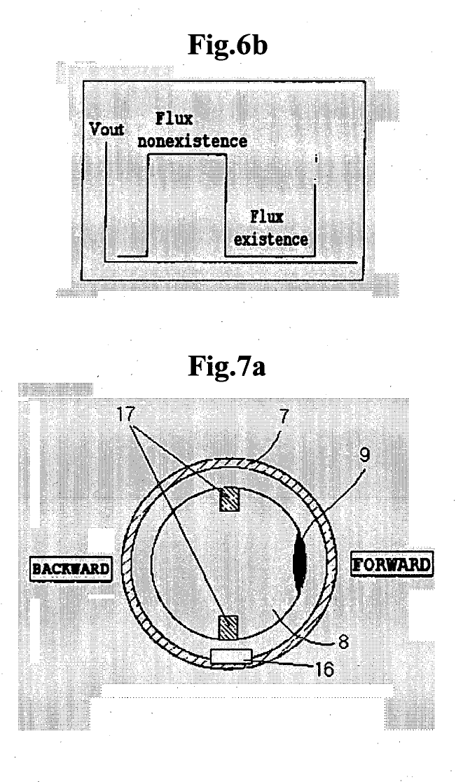

A hall Integrated Circuit (IC) which is a non-contact type sensor, instead of the contact type push switch, can be used as the sensor. FIGS. 6a and 6b are a circuit diagram of the hall IC and a waveform diagram showing an output voltage thereof, respectively.

The hall IC is a sensor for detecting magnetic flux of a magnet and has the construction as shown in FIG. 6a. As shown in FIG. 6b, if magnetic flux is not detected, a high value is output through an output terminal. On the other hand, if a magnet approaches an X axis direction, magnetic flux is detected, so a low value is output through the output terminal.

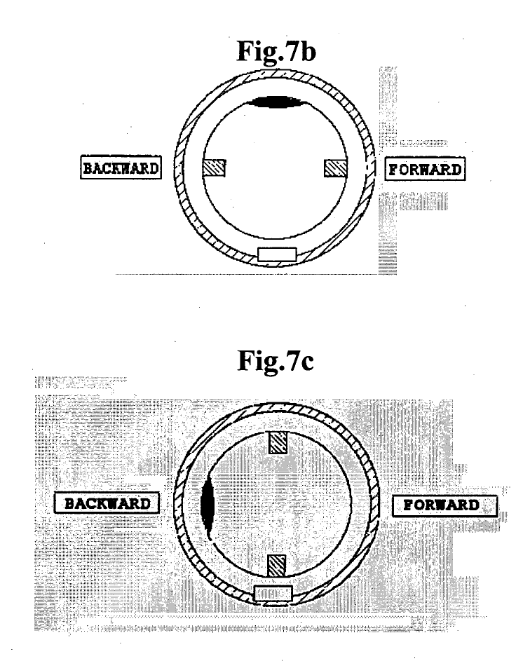

Using these principles, the hall IC 16 is disposed at the external casing 7 of the camera and magnet substances 17 are arranged on the lens tube 8, as shown in FIGS. 7a to 7c.

As shown in FIG. 7a, while the camera lens 9 faces forward of the mobile terminal, the hall IC 16 detects magnetic flux formed by the magnet of the lens tube 8 and outputs a low value. As shown in FIG. 7b, while the user pushes an external command button and so the camera lens 9 rotates, the hall IC 16 does not detect magnetic flux of the magnet and outputs a high value. Meanwhile, as shown in FIG. 7c, while the lens 9 faces backward, the hall IC 16 detects magnetic flux again and outputs a low value. The control unit drives and stops the motor according to the output values.

In the circuit as described above, the control unit is implemented so that it drives the motor when the hall IC 16 outputs a high value, while the control unit stops the rotation of the motor when the hall IC 16 outputs a low value.

Initializing Process

In the construction using one button and one sensor, since the present direction of the lens cannot be known when power of the mobile terminal is turned on, there is required a process of initializing the position of the lens to allow the lens to face a certain direction when power is turned on so as to know the direction of the lens. After initializing the position of the lens, the control unit assigns a flag value for camera position information to a memory in the control unit, drives the camera through the button manipulation of the user, and then stores the camera position information as the flag value. Therefore, the position of the lens can be adjusted using one sensor and one button.

Hereinafter, the initializing process executed in the construction using one sensor and one button is described in detail.

When power of the mobile terminal is turned on, the camera lens is positioned to face backward, forward or upward.

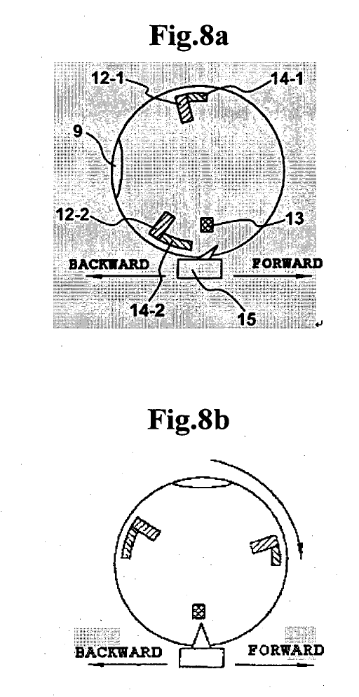

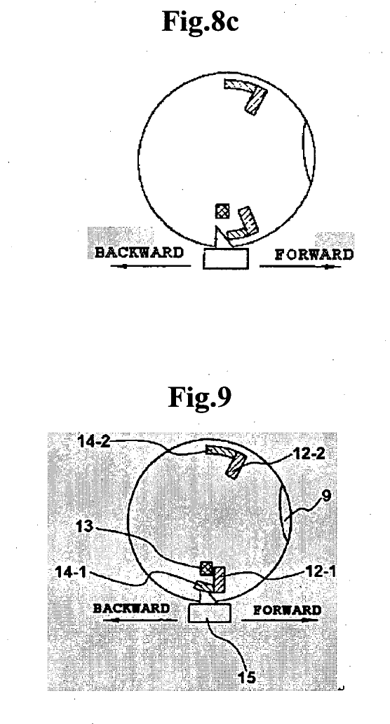

FIGS. 8a to 8c illustrate an initializing process executed in the case where the lens faces backward when the user turns on power. For simplicity of the drawings, the external casing is not shown.

As shown in FIG. 8a, while the lens 9 faces backward, a second projection 14-2 pushes the push switch 15. In this state, when the user turns on power of the mobile terminal, the motor is driven clockwise, so the lens tube starts to rotate clockwise.

In this case, the output value (high or low) of the sensor (push switch 15) must be ignored for a predetermined period of time Δt (a short period of time for which the push switch is transitioned from its turned-on state (pushed state) to its turned-off state (not pushed state)). The reason for this is that the push switch 15 has been previously pushed while the lens faces backward and the output value of the sensor at this time is a value for allowing the control unit to stop the motor, so the motor is not driven.

Since the output value of the push switch 15 is ignored for the time Δt, the motor is driven to rotate the lens as shown in FIG. 8b. After that, the output value of the push switch 15 is checked and the motor is stopped to stop the lens when the output value of the push switch is high (when the lens faces forward) as shown in FIG. 8c. Thereafter, a flag value assigned to the memory of the control unit is set to “0”. In this case, flag=0 represents that the lens 9 faces forward.

In the case where the lens faces forward as shown in FIG. 9 when power is turned on, the output value of the push switch is ignored for the time Δt, so the motor is driven clockwise, but the lens is not rotated due to a safety device 18 and a stopper 19. After the time Δt, the motor is stopped by the output value of the push switch. Thereafter, a flag value assigned to the memory of the control unit is set to “0”.

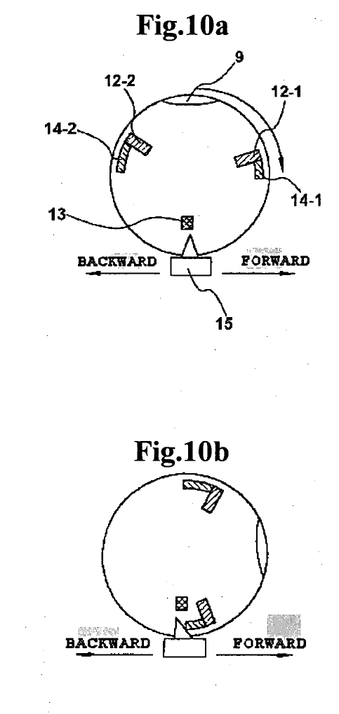

When the lens 9 faces upward as shown in FIG. 10a, the motor is driven clockwise. When the first projection pushes the push switch 15 as shown in FIG. 10b, the motor is stopped. At this time, the flag value assigned to the memory of the control unit is set to “0”.

Through the above initializing process, the lens automatically faces forward when the user turns on power in the case where one sensor and one button are used.

Hereinafter, operations after the initializing process are described.

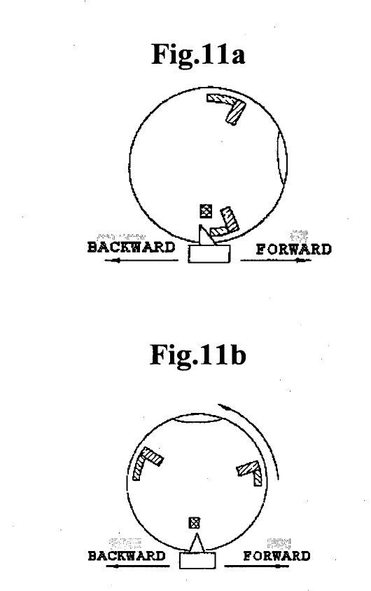

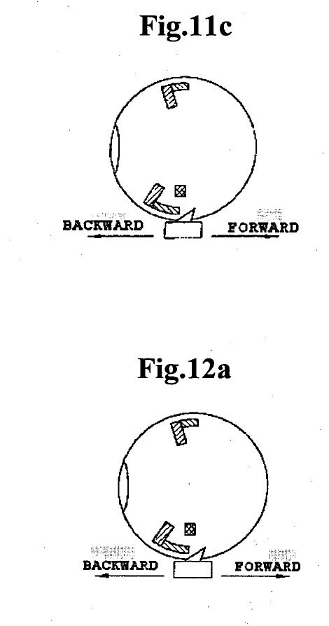

FIGS. 11a to 11c illustrate an operation performed when the user pushes an external command button if flag=0 (that is, after flag=0 in the initialized state or by the manipulation of the user).

In FIG. 11a, when the external command button is pushed, the present position of the lens is checked by the flag value (if flag=0, the lens is positioned to face forward, while if flag=1, the lens is positioned to face backward). Further, the output value of the sensor is ignored for the time Δt, so the motor is driven counterclockwise to rotate the lens tube counterclockwise as shown in FIG. 11b. The lens tube is stopped if the sensor senses the second projection as shown in FIG. 11c. Thereafter, the flag value is inverted to be set to “1”.

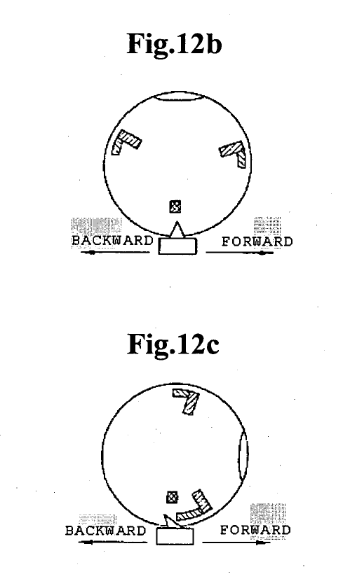

FIGS. 12a to 12c illustrate an operation performed when the user pushes the external command button if flag=1.

In FIG. 12a, when the external command button is pushed, it is checked that the flag is 1, and the output value of the sensor is ignored for the time Δt. Therefore, the motor is driven clockwise to rotate the lens tube clockwise as shown in FIG. 12b. The lens tube is stopped if the sensor senses the second projection as shown in FIG. 12c. Thereafter, the flag value is inverted to be set to “0”.

As described above, the push switch is used as the sensor in the embodiment, but any of a contact-type sensor and a non-contact type sensor (for example, hall IC) besides the push switch can be used as the sensor.

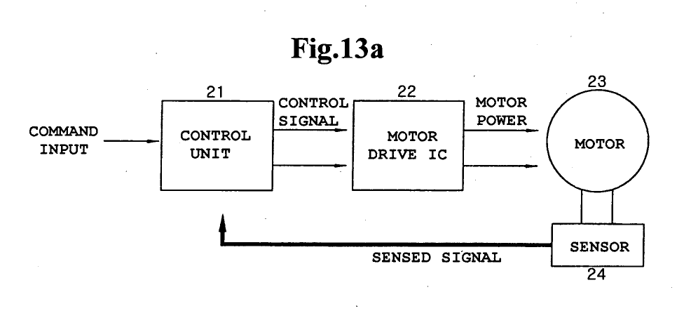

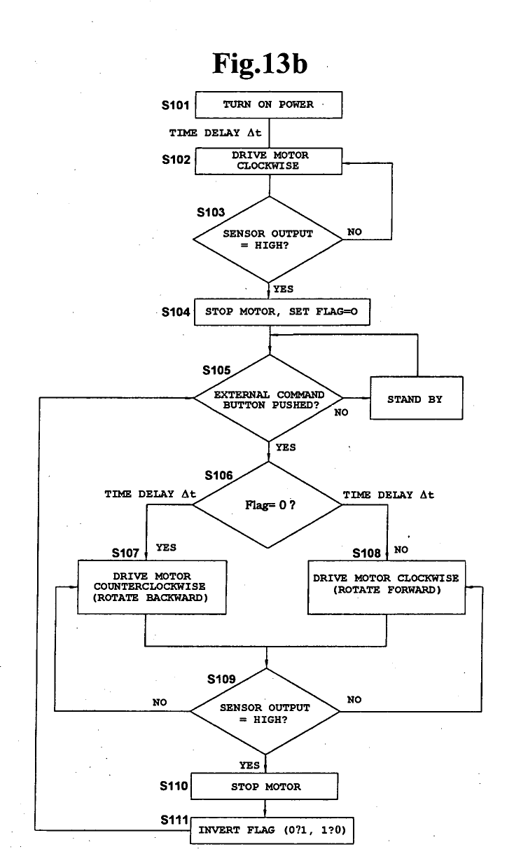

FIGS. 13a and 13b are a block diagram of a camera rotation drive module using one external command button and one sensor according to the present invention and a flowchart showing the operation thereof, respectively.

Referring to FIG. 13a, if the user pushes an external command button, after power of a mobile terminal is turned on and so the above initializing process is executed, a control unit 21 receives a value corresponding to the external command button and transmits the value to a motor drive IC 22. The motor drive IC 22 drives a motor 23 to rotate a lens tube. When a sensor 24 senses a projection during the rotation of the lens tube, the sensor 24 transmits a sensed value to the control unit 21 to stop the motor 23 through the motor drive IC 22.

Referring to the flowchart of FIG. 13b, when power is turned on at step S101, the output value of the sensor is ignored for a time delay Δt (in spite of the output value of the sensor), and the motor is driven clockwise at step S102. Steps 103 and 102 are repeated until the sensor detects the projection and outputs a high value. The motor is stopped at step S104 if the projection is detected. Steps S102 to S104 correspond to an initializing process.

If the user pushes the external command button at step S105, the position of the lens is checked at step S106. If the flag is 0 after a time delay Δt, the motor is rotated counterclockwise at step S107, while if the flag is not “0”, the motor is rotated clockwise at step S108. If the sensor detects the projection and outputs a high value at step S109, the motor is stopped at step S110. Thereafter, the flag value is inverted at step S111, and then the process returns to step S105 to stand by for the input of the external command through the external command button.

Embodiment Using Two Sensors and One Button

Two sensors and one button can be used in another embodiment of the present invention.

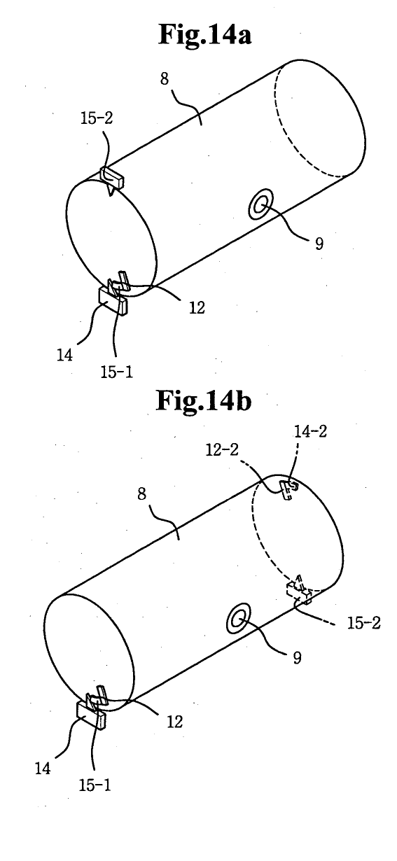

FIGS. 14a and 14b are perspective views of a lens tube 8 when two sensors and one button are used. For simplicity of the drawings, an external casing is not shown.

In the case where two sensors 15-1,15-2 are used, two sensors can be arranged together on one of both sides of the lens tube 8 as shown in FIG. 14a. Alternatively, two sensors 15-1,15-2 may be arranged on both sides of the lens tube, respectively, as shown in FIG. 14b. In the former case, one projection 14 is required, while, in the latter case, two projections 14-1,14-2 are required.

The projection must be arranged at a suitable position on each side of the lens tube in consideration of the position of the external casing and the lens.

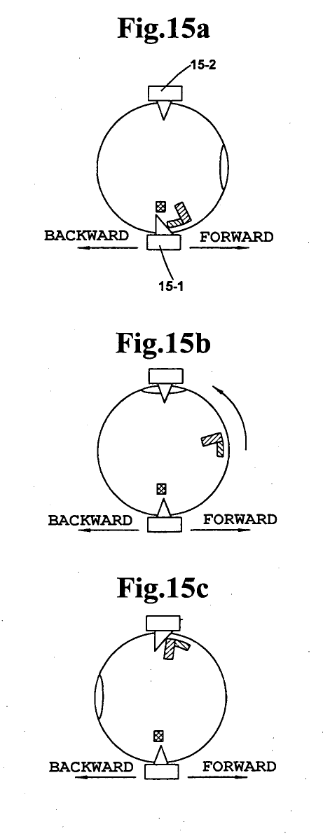

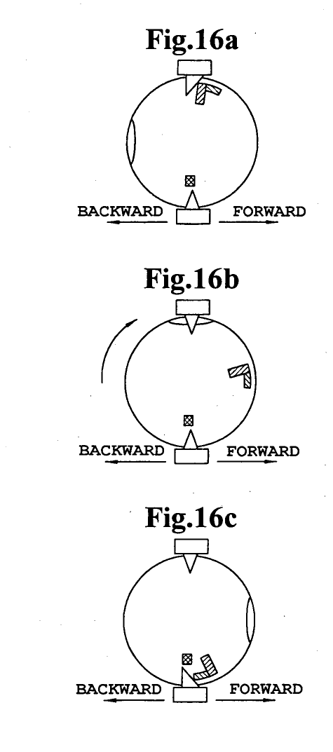

FIGS. 15a to 15c and FIGS. 16a to 16c illustrate an operation performed when two sensors are arranged as shown in FIG. 14a. In FIG. 15a, when the external button is pushed, the lens 9 rotates counterclockwise, comes in the position shown in FIG. 15b, and finally comes in the position as shown in FIG. 15c. In FIG. 16a, when the external button is pushed, the lens 9 rotates clockwise, comes in the position shown in FIG. 16b, and finally comes in the position as shown in FIG. 16c.

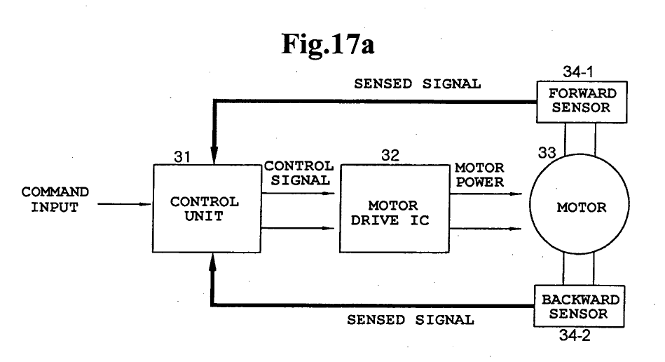

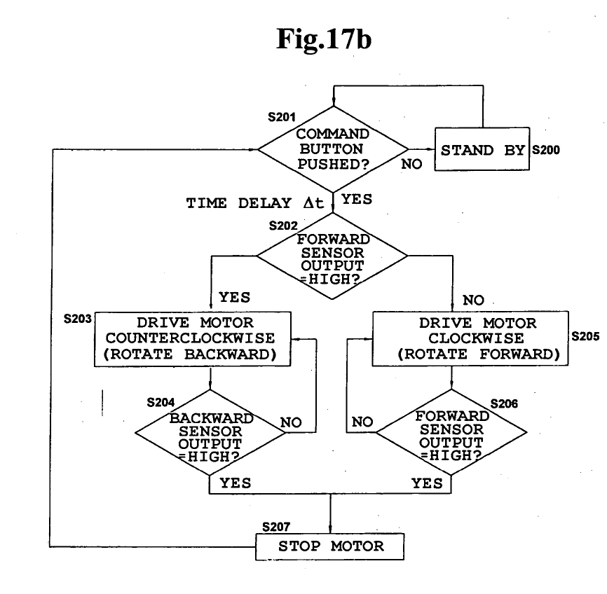

FIG. 17a is a block diagram showing the construction of a camera rotation drive module when two sensors and one button are used, and FIG. 17b is a flowchart of an algorithm executed by the drive module.

In the case where two sensors are used, there is no need to use a flag value, differently from the case where one sensor and one button are used. Further, since two sensors can sense a direction which the lens faces at the present time, an initializing process is not necessary.

Referring to FIG. 17a, if the user pushes an external command button, a control unit 31 receives a signal corresponding to the external command button, and a motor drive IC 32 drives a motor 33 in response to the signal. When a forward sensor 34a or backward sensor 34b senses a projection of the lens (in this case, the forward sensor is a sensor arranged to sense the projection when the lens faces forward, and the backward sensor is a sensor arranged to sense the projection when the lens faces backward), the output value of the sensor at this time is transmitted to the control unit 31, and the motor is stopped by the output value of the sensor.

Referring to FIG. 17b, it is checked that an external command button is pushed by the user at step S201 while the camera rotation drive module stands by at step S200.

After a time delay Δt, if the output value of the forward sensor 34a is high at step S202, the motor is driven counterclockwise to rotate the lens backward at step S203. If the output value of the backward sensor 34b becomes high at step S204, the motor is stopped at step S207 and the camera rotation drive module stands by at step S200.

After a time delay Δt, if the output value of the backward sensor 34b is high at step S202, the motor is driven clockwise at step S205. If the output value of the forward sensor 34a becomes high at step S206, the motor is stopped at step S207, and the camera rotation drive module stands by at step S200.

Embodiment Using One Sensor and Two Buttons

One sensor and two buttons can be used in a further embodiment of the present invention.

When two buttons are used, one is used to rotate a lens to face forward, and the other is used to rotate the lens to face backward.

Except that the number of external command buttons is two and the initializing process is not necessary, the construction and operation of this embodiment is the same as that of the above embodiment using one sensor and one button.

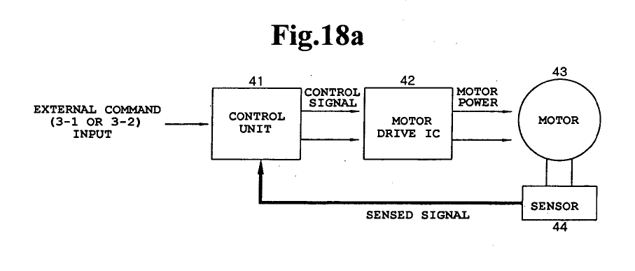

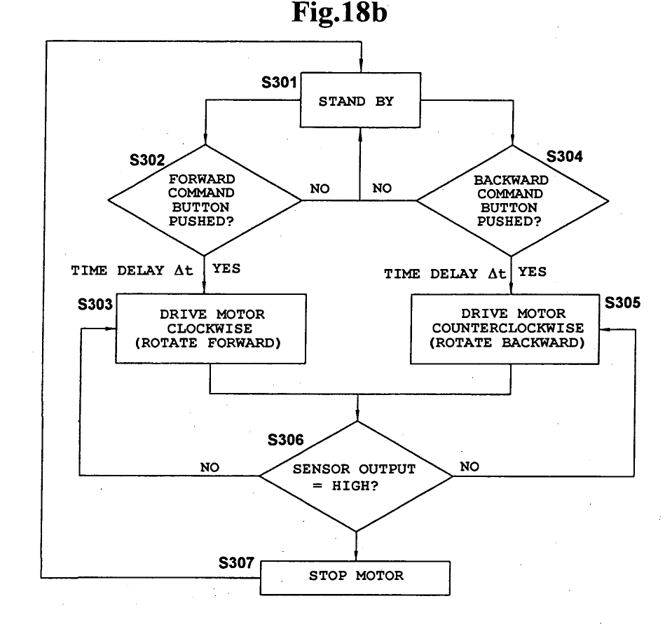

FIG. 18a is a block diagram showing the construction of a camera rotation drive module when one sensor and two buttons are used, and FIG. 18b is a flowchart of an algorithm performed by the drive module.

Referring to FIG. 18a, when the user pushes one of forward and backward command buttons, a signal corresponding to the pushed button is transmitted to a control unit 41. The control unit 41 transmits a control signal to a motor drive IC 42 to rotate a motor 43. Further, if the lens is positioned to face a desired direction and so a sensor 44 senses the position of the lens, a signal indicating that the sensor 44 sensed the position of the lens is transferred to the control unit 41 to stop the motor.

Referring to FIG. 18b, if the user pushes the forward command button while the camera rotation drive module stands by for a command at step S301, the process moves to step S302, while if the user pushes the backward command button, the process moves to step S304.

If it is checked that the forward command button is pushed at step S302, the motor is driven clockwise to allow the lens to face forward after a time delay Δt at step S303. If the lens faces forward and so the output value of the sensor becomes high at step S306, the motor is stopped at step S307, and the camera rotation drive module returns to step S301 to stand by.

If it is checked that the backward command button is pushed at step S304, the motor is driven counterclockwise to allow the lens to face backward after the time delay Δt at step S305. If the lens faces backward and so the output value of the sensor becomes high at step S306, the motor is stopped at step S307, and the camera rotation drive module returns to step S301 to stand by.

Embodiment Using Two Sensors and Two Buttons

Two sensors and two buttons can be used in still another embodiment of the present invention.

Except that the number of external command buttons is two, the construction and operation of this embodiment is the same as that of the above embodiment using two sensors and one button.

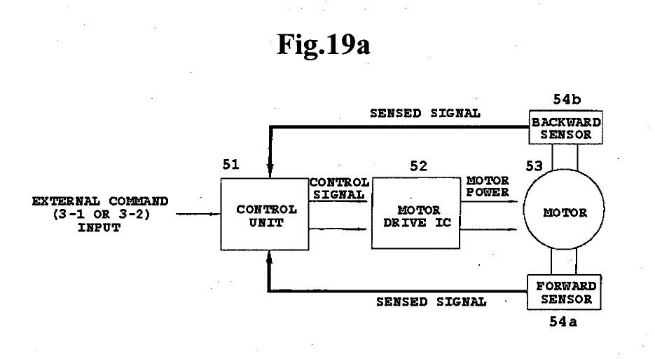

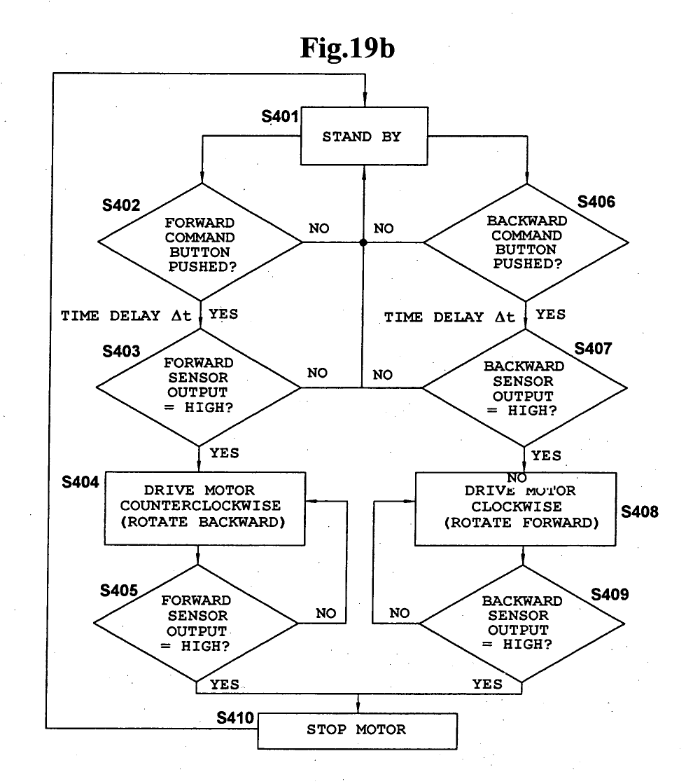

FIG. 19a is a block diagram showing the construction of a camera rotation drive module when two sensors and two buttons are used, and FIG. 19b is a flowchart of an algorithm executed by the drive module.

Similar to the above embodiment using two sensors and one button, in the case where two sensors are used, two sensors can be arranged together on one of both sides of the lens tube as shown in FIG. 14a. Alternatively, two sensors may be arranged on both sides of the lens tube, respectively, as shown in FIG. 14b. In the former case, one projection is required, while, in the latter case, two projections are required. In this embodiment, it is assumed that two sensors are arranged together on one of both sides of the lens tube as shown in FIG. 14a.

Referring to FIG. 19a, when the user pushes a forward or backward command button, a control unit 51 receives a signal corresponding to the pushed button and transmits a control signal to a motor drive IC 52 to drive a motor 53. If a forward or backward sensor 54a or 54b senses a projection according to the pushed command button and transmits a sensed signal to the control unit 51, the motor is stopped.

Referring to FIG. 19b, if the user pushes the forward command button at step S402 while the camera rotation drive module stands by at step S401, it is checked whether the output value of the forward sensor is high, that is, whether the lens faces forward, at step S403. If it is checked that the lens has previously faced forward, the camera rotation drive module ignores the command and returns to step S401 to stand by for a command. If the lens faces backward, the motor is driven clockwise to rotate the lens tube at step S404. When the output value of the forward sensor becomes high, that is, when the lens faces forward, at step S405, the motor is stopped at step S410 and the camera rotation drive module returns to step S401 to stand by for a command.

If the user pushes the backward command button at step S406, it is checked whether the output value of the backward sensor is high, that is, whether the lens faces backward, at step S407. If it is checked that the lens has previously faced backward, the camera rotation drive module ignores the command and returns to step S401 to stand by. If the lens does not face backward, the motor is driven counterclockwise at step S408. When the output value of the backward sensor becomes high, that is, when the lens faces backward, at step S409, the motor is stopped at step S410 and the camera rotation drive module returns to step S401 to stand by.

Drive Module Having Parking Function

A camera rotation drive module having a parking function is described as still another embodiment of the present invention. Parking represents a state in which a camera lens faces toward the inside of a casing of a mobile terminal and is not exposed to the outside. Therefore, when the camera mounted in the mobile terminal is not used, the lens is parked to be protected against infiltration of impurities.

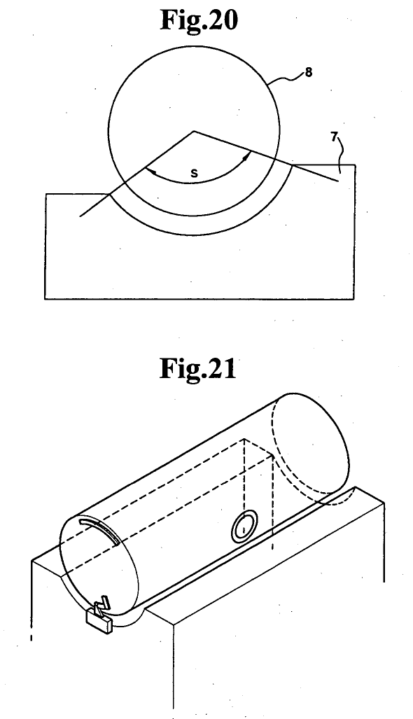

Parking represents a state in which the camera lens faces toward the inside of a casing of a mobile terminal without being exposed to the outside and is arranged to face area “S” in FIG. 20. For this operation, there are required the extension of length of a projection and the modification of an algorithm in the above embodiments which do not have the parking structure of the present invention.

FIG. 21 is a perspective view showing a lens tube and an external casing in a construction using one sensor and one button, or construction using one sensor and two buttons in the case of embodiments including the parking structure. There is no need to consider an external casing in the above embodiments not including the parking structure, but the external casing must be considered so as to describe the parking structure.

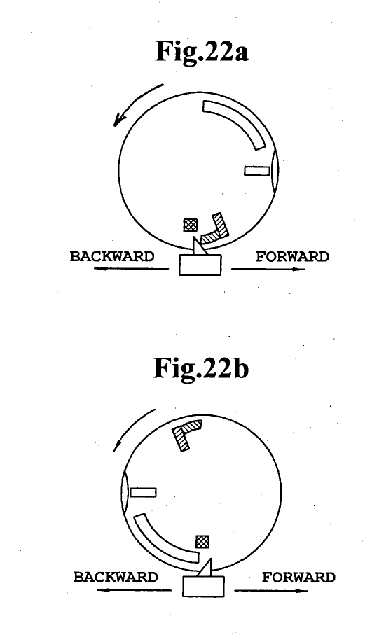

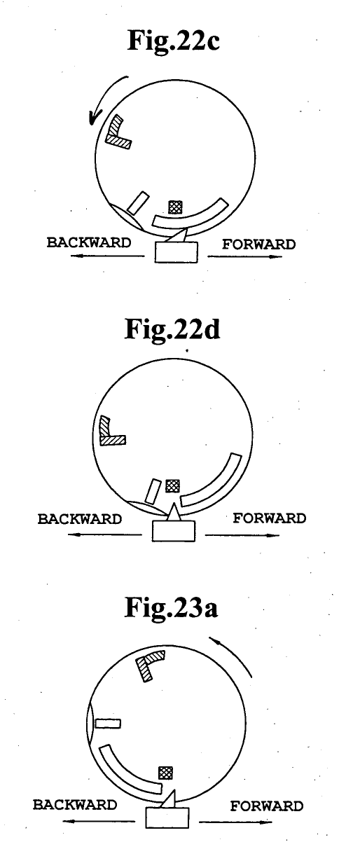

FIGS. 22a to 22d illustrate a parking operation performed in the case where a lens faces forward when the user pushes a parking button. In the state of FIG. 22a, if a parking button is pushed (in this case, a separate parking button can be provided, or a power button can be set to the parking button), the lens is parked as shown in FIG. 22d through the states of FIGS. 22b and 22c.

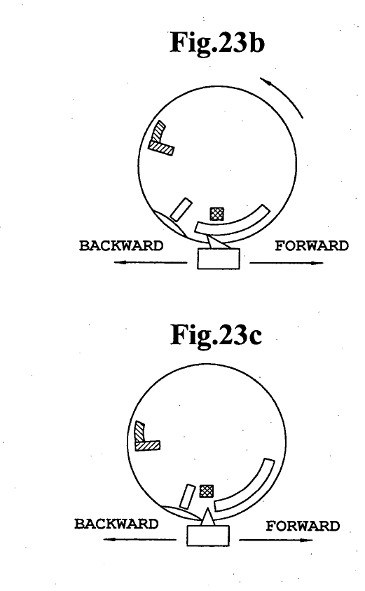

FIGS. 23a to 23c illustrate a parking operation performed in the case where the lens faces backward when the user pushes the parking button. In the state of FIG. 23a, if the parking button is pushed, the lens is parked as shown in FIG. 23c through the state of FIG. 23b.

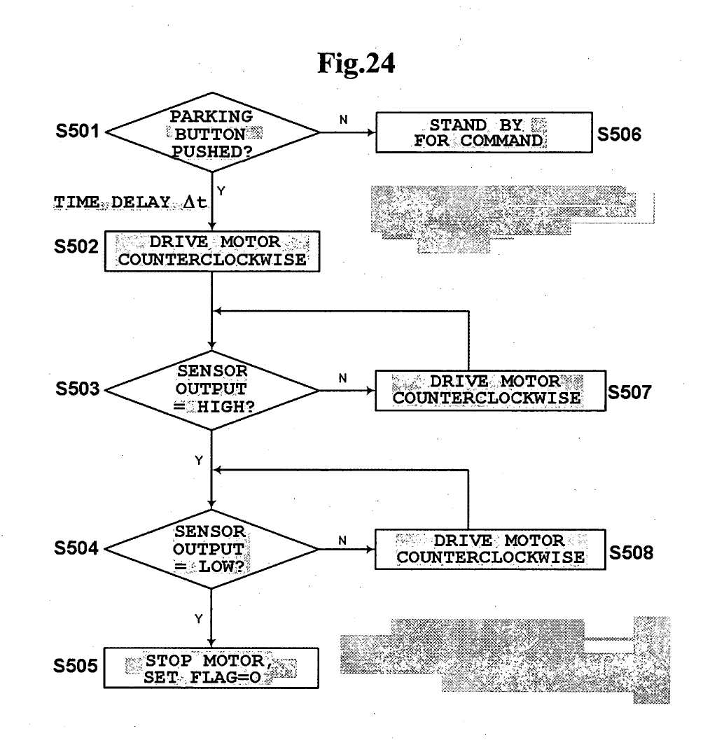

FIG. 24 is a view showing a parking algorithm when one sensor is used (one sensor and one button, or one sensor and two buttons).

If a parking button is pushed at step S501 while the camera rotation drive module stands by for a command at step S506, a motor is driven counterclockwise after a time delay Δt at step S502. Even though the output value of the sensor becomes high at step S503, the motor is continuously driven to rotate a lens tube counterclockwise at step S507. If the output value of the sensor becomes low at step S504, the motor is stopped and a flag is set to “0” at step S505, so the lens is parked. Further, if the output value of the sensor is not low at step S504, the motor is driven counterclockwise at step S508. In this case, the step S505 of setting the flag to 0 is omitted when one sensor and two buttons are used.

An algorithm using the parking structure is different from an algorithm without using the parking structure in that the motor is not stopped and is continuously rotated even though the output value of the sensor becomes high, and the motor is stopped after the output value of the sensor becomes low.

Measurement of Angle of Projection in Parking

The embodiment including the parking structure of the present invention is different from embodiments not including the parking structure in that a projection is extended, and the output value of a sensor is ignored and a motor is continuously rotated even though the output value of the sensor becomes high, as described above.

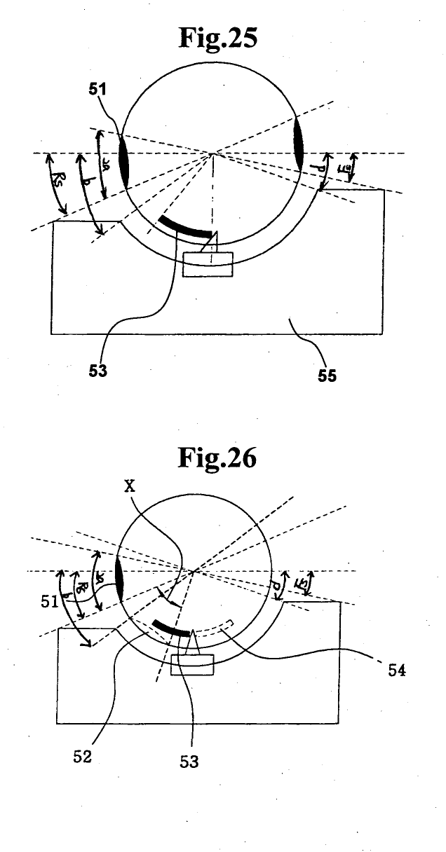

Referring to FIG. 25, a parking position of the lens is determined depending on the extended length of a projection 53. If the projection 53 is formed to be excessively short, the lens cannot enter area “S” of FIG. 20, while if it is formed to be excessively long, the lens would be parked away from the area “S”. Therefore, the length of the projection 53 must be defined to enable the lens to be parked. The length of the projection 53 is varied according to the size of the lens tube, so the projection 53 must be defined by an angle, not a length.

Referring to FIG. 25, angles are defined below.

2a: the arc angle of a camera lens

b: the angle between a rear inner edge of an external casing and a horizontal and transverse center line of a lens tube

d: the angle between a forward inner edge of the external casing and the horizontal and transverse center line of the lens tube

Fs: the angle between a forward outer edge of the external casing and the horizontal and transverse center line of the lens tube

Rs: the angle between a rear outer edge of the external casing and the horizontal and transverse center line of the lens tube

Minimum Value of Projection Angle for Parking

A minimum projection angle necessary for parking, that is, a projection angle required to park the lens just inside a required parking range, is described.

Referring to FIG. 26, the projection is formed to have a suitable length to such an extent that the sensor can first sense one end 53 of the projection (that is, the sensor outputs a high value) while the lens 51 faces backward, and cannot sense the other end 54 thereof (that is, the output value of the sensor is transitioned to low from high) while the lens 51 is parked just inside a required parking range, as indicated by a dotted line 52.

An angle between the positions of the lens, indicated by a solid line and a dotted line, respectively, in FIG. 26, is a minimum projection angle X necessary for parking, which is defined by the following Equation [1].

X(minimumprojectionangle)−2a+b−Rs (unit:degree) [1]

Maximum Projection Angle When the Lens is Parked Furthest Inside a Required Parking Range

A maximum projection angle necessary for parking, that is, a projection angle required to park the lens furthest inside a required parking range, is described.

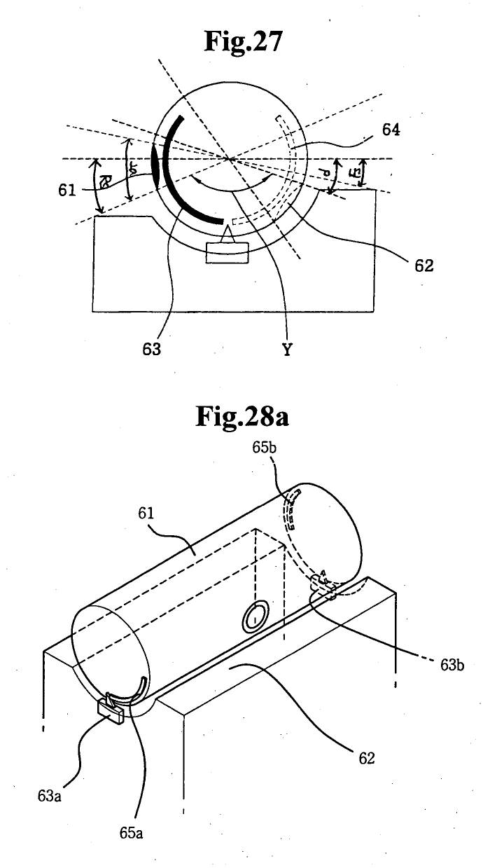

Referring to FIG. 27, the projection is formed to have a suitable length to such an extent that the sensor can first sense one end 63 of the projection (that is, the sensor outputs a high value) while a lens 61 faces backward, and the sensor does not sense the other end 64 thereof (that is, the output value of the sensor is transitioned to low from high) while the lens 61 is parked furthest inside a required parking range (as indicated by a dotted line 62).

Referring to FIG. 27, an angle between the positions of the lens, hatched by a solid line and a dotted line, respectively, is the maximum projection angle Y, which is defined by the following Equation [2].

Y(maximumprojectionangle)=180−Rs−d (unit:degree) [2]

Therefore, the projection angle Z must be within a range defined in the following Equation [3] from Equations [1] and [2] in the embodiment including the parking structure.

2a+b−Rs≦Z≦180−Rs−d, where:

Embodiment Using Two Sensors (Two Sensors and One Button, and Two Sensors and Two Buttons)

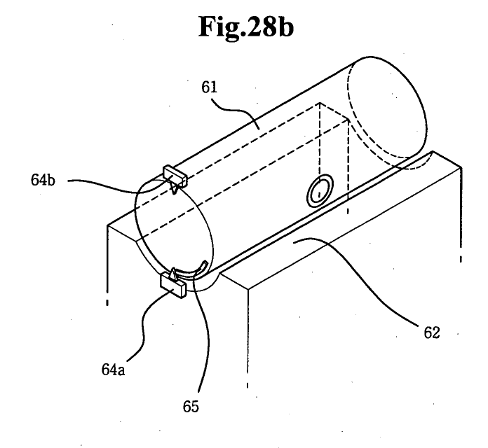

FIGS. 28a and 28b are perspective views showing a lens tube 61 and an external casing 62 when two sensors are used.

In the case where two sensors are used, two sensors 64a and 64b can be arranged together on one of both sides of the lens tube 61 as shown in FIG. 28b. Alternatively, two sensors 63a and 63b can be arranged on both sides of the lens tube 61, respectively, as shown in FIG. 28a. In the latter case, two projections are required, while, in the former case, one projection is required.

The length of the projection is limited to the same range as that of the above embodiment using one sensor.

The definite position of the sensor is varied according to the range in which the sensor is parked.

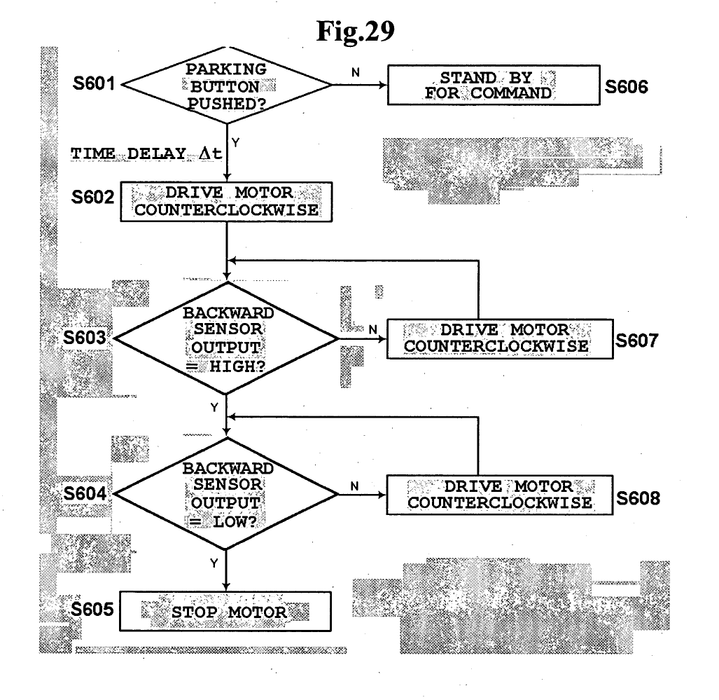

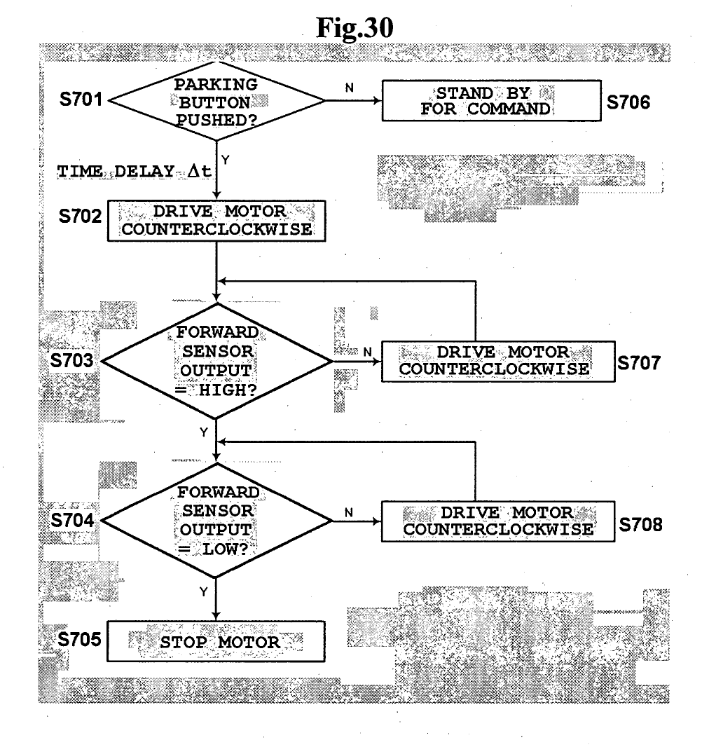

FIG. 29 is a flowchart showing a parking algorithm executed when two sensors are arranged on both sides of the lens tube, respectively, in the case where two sensors are used.

If a parking button is pushed at step S601 while a camera rotation drive module stands by for a command at step S606, a motor is driven counterclockwise after a time delay Δt at step S602. Even though the output value of a backward sensor (as described above, the backward sensor is a sensor for sensing a projection when the lens faces backward) becomes high at step S603, the motor is continuously driven counterclockwise at step S607. If the output value of the backward sensor becomes low at step S604, the motor is stopped and the lens is parked at step S605. Further, if the output value of the backward sensor is not low at step S604, the motor is driven counterclockwise at step S608.

FIG. 29 is a flowchart of an algorithm executed when two sensors are arranged together on one side of the lens tube in the case where two sensors are used.

If a parking button is pushed at step S701 while a camera rotation drive module stands by for a command at step S706, a motor is driven counterclockwise after a time delay Δt at step S702. Even though the output value of a forward sensor (as described above, the forward sensor is a sensor for sensing a projection when the lens faces forward) becomes high at step S703, the motor is continuously driven counterclockwise at step S707. If the output value of the forward sensor becomes low at step S704, the motor is stopped and the lens is parked at step S705. Further, if the output value of the forward sensor is not low at step S704, the motor is driven counterclockwise at step S708.

As described above, the present invention provides a camera rotation drive module of a mobile terminal equipped with a camera, which allows a user to easily use the camera by forwardly and backwardly rotating a camera lens mounted in the mobile terminal through the button manipulation of the user according to the construction and algorithm of the present invention.

The present invention is advantageous in that the manipulation of the camera lens can be carried out using only one button in an embodiment using one button and one sensor among embodiments of the present invention, thus simplifying an exterior shape of a mobile terminal, and reducing costs because of the use of only one sensor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The embodiments of the invention in which an exclusive property or privilege is claimed are defined as follows:

1. A camera rotation drive module, comprising:
an external command button arranged on an external casing of a mobile terminal;
a motor unit mounted in the mobile terminal and driven by allowing the external command button to be pushed to rotate a lens tube;
a camera unit comprised of the lens tube, a lens, a sensor and a camera casing and mounted in the mobile terminal; and
a control unit for stopping the motor unit in response to an output value of the sensor;
wherein the lens is mounted on the lens tube, and the sensor is arranged at a position where the sensor can sense at least one projection formed on the lens tube when the lens is located at a predetermined position.

2. The camera rotation drive module according to claim 1, wherein the motor unit is driven after a user pushes the external command button and then a predetermined time Δt has elapsed.

3. The camera rotation drive module according to claim 1, wherein the sensor is a push switch.

4. The camera rotation drive module according to claim 1, wherein the sensor is a hall Integrated Circuit (IC), and the projection is a magnetic substance.

5. The camera rotation drive module according to claim 1, further comprising a stopper attached to the camera casing and a stopper attached to the projection.

6. The camera rotation drive module according to claim 1, wherein the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube; and
Rs is an angle between a rear outer edge of the external casing and the horizontal and transverse center line of the lens tube.

7. A method of rotating a lens of a camera, comprising the steps of:
(a) assigning a flag to a memory in a mobile terminal when power of the mobile terminal is turned on, and setting a value of the flag to “0”;
(b) pushing an external command button mounted on an external casing of the mobile terminal;
(c) determining whether the flag value is “0” or “1”;
(d) driving a motor counterclockwise after a predetermined time Δt if the flag value is “0”, while driving the motor clockwise after the time Δt if the flag value is “1”;
(e) sensing at least one projection formed on a lens tube of the camera by a sensor arranged in a camera casing;
(f) stopping the motor;
(g) inverting the flag value, such as by setting “0” to “1” or by setting “1” to “0”; and
(h) repeatedly performing steps (b) to (g) after an external command button is pushed.

8. The camera lens rotating method according to claim 7, wherein:
the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube; and
Rs is an angle between a rear outer edge of the external casing and the horizontal and transverse center line of the lens tube;
the camera casing has a lens parking button mounted thereon; and
the camera lens rotating method further comprises the steps of driving the motor counterclockwise after a predetermined time Δt if a power off button or the lens parking button is pushed, and stopping the motor when an output value of the sensor is transitioned to low from high.

9. A camera rotation drive module, comprising:
an external command button arranged on an external casing of a mobile terminal;
a motor unit mounted in the mobile terminal and driven by allowing the external command button to be pushed to rotate a lens tube;
a camera unit comprised of the lens tube, a lens, two sensors and a camera casing and mounted in the mobile terminal; and
a control unit for stopping the motor unit in response to output values of the sensors;
wherein the lens is mounted on the lens tube, and the sensors are arranged at positions where the sensors can sense at least one projection formed on the lens tube when the lens is located at a predetermined position.

10. The camera rotation drive module according to claim 9, wherein the motor unit is driven after a user pushes the external command button and then a predetermined time Δt has elapsed.

11. The camera rotation drive module according to claim 9, wherein the sensors are push switches.

12. The camera rotation drive module according to claim 9, wherein the sensors are hall ICs, and the projection is a magnetic substance.

13. The camera rotation drive module according to claim 9, further comprising a stopper attached to the camera casing, another projection attached to the lens tube, and a stopper attached to the projection.

14. The camera rotation drive module according to claim 9, wherein the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube; and
Rs is an angle between a rear outer edge of the external casing and the horizontal and transverse center line of the lens tube.

15. A method of rotating a lens of a camera, comprising the steps of:
pushing an external command button mounted on an external casing of a mobile terminal;
checking an output value of a sensor (forward sensor) which outputs a high value when a lens faces a user;
if the output value of the forward sensor is high, performing the steps of driving a motor counterclockwise after a predetermined time Δt, and sensing a projection by a sensor (backward sensor) which outputs a high value when the lens faces a direction away from the user and stopping the motor when the sensed value becomes high; and
if the output value of the forward sensor is low, performing the steps of driving the motor clockwise after a predetermined time Δt, sensing the projection by the forward sensor and stopping the motor if the sensed value becomes high, and returning to a standby state for input of an external command.

16. The camera lens rotating method according to claim 15, wherein:
the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube;
Rs is an angle between a rear outer edge of the external casing and the horizontal and transverse center line of the lens tube;
the camera casing has a lens parking button mounted thereon; and
the camera lens rotating method further comprises the steps of driving the motor counterclockwise after a predetermined time Δt if a power off button or the lens parking button is pushed, and stopping the motor when an output value of the sensor is transitioned to low from high.

17. A camera rotation drive module, comprising:
two external command buttons arranged on an external casing of a mobile terminal;
a motor unit mounted in the mobile terminal and driven by allowing one of the external command buttons to be pushed to rotate a lens tube;
a camera unit comprised of the lens tube, a lens, a sensor and a camera casing and mounted in the mobile terminal; and
a control unit for stopping the motor unit in response to an output value of the sensor;
wherein the lens is mounted on the lens tube, and the sensor is arranged at a position where the sensor can sense at least one projection formed on the lens tube when the lens is located at a predetermined position.

18. The camera rotation drive module according to claim 17, wherein the motor unit is driven after a user pushes the external command buttons and then a predetermined time Δt has elapsed.

19. The camera rotation drive module according to claim 17, wherein a first one of the two external command buttons generates a signal for causing the lens to face a user, and a second one thereof generates a signal for causing the lens to face a direction away from the user.

20. The camera rotation drive module according to claim 17, wherein the sensor is a push switch.

21. The camera rotation drive module according to claim 17, wherein the sensor is a hall IC, and the projection is a magnetic substance.

22. The camera rotation drive module according to claim 17, further comprising a stopper attached to the camera casing, another projection attached to the lens tube, and a stopper attached to the projection.

23. The camera rotation drive module according to claim 17, wherein the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube; and
Rs is an angle between a rear outer edge of the external casing and the horizontal and transverse center line of the lens tube.

24. A method of rotating a lens of a camera, comprising the steps of:
pushing one of two external command buttons;
if the pushed button is a forward command button, performing the steps of (a) moving to a standby state for input of an external command when an output value of a sensor is high, (b) driving a motor mounted in a mobile terminal clockwise after a predetermined time Δt when an output value of the sensor is low, (c) sensing at least one projection in the lens tube of the camera by the sensor arranged at a predetermined position in a camera casing to output a sensed value as a high value, (d) stopping the motor, and e) moving to a standby state for input of an external command; and
if the pushed button is a backward command button, performing the steps of (f) moving to a standby state for input of an external command when an output value of a sensor is high value when the lens faces a direction away from the user, is high, (g) driving the motor mounted in the mobile terminal counterclockwise after a predetermined time Δt when an output value of the sensor is low, (h) sensing at least one projection in the lens tube of the camera by the sensor arranged at a predetermined position in the camera casing to output a sensed value as a high value, (i) stopping the motor, and (j) moving to a standby state for input of an external command.

25. The camera lens rotating method according to claim 24, wherein:
the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube;
Rs is an angle between a rear outer edge of the external casing and the horizontal and transverse center line of the lens tube;
the camera casing has a lens parking button mounted thereon; and
the camera lens rotating method further comprises the steps of driving the motor counterclockwise after a predetermined time Δt if a power off button or the lens parking button is pushed, and stopping the motor when an output value of the sensor is transitioned to low from high.

26. A camera rotation drive module, comprising:
two external command buttons arranged on an external casing of a mobile terminal;
a motor unit mounted in the mobile terminal and driven by the external command buttons to rotate a lens tube;
a camera unit comprised of the lens tube, a lens, two sensors and a camera casing and mounted in the mobile terminal; and
a control unit for stopping the motor unit in response to output values of the sensors;
wherein the lens is mounted on the lens tube, and the sensors are arranged at positions where the sensors can sense at least one projection formed on the lens tube when the lens is located at a predetermined position.

27. The camera rotation drive module according to claim 26, wherein the motor unit is driven after a user pushes the external command buttons and then a predetermined time Δt has elapsed.

28. The camera rotation drive module according to claim 26, wherein a first one of the two external command buttons causes the lens to face forward, and a second one thereof causes the lens to face backward.

29. The camera rotation drive module according to claim 26, wherein the sensors are push switches.

30. The camera rotation drive module according to claim 26, wherein the sensors are hall ICs, and the projection is a magnetic substance.

31. The camera rotation drive module according to claim 26, further comprising a stopper attached to the camera casing, another projection attached to the lens tube, and a stopper attached to the projection.

32. The camera rotation drive module according to claim 26, wherein the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube; and
Rs is an angle between a rear outer edge of the external casing and the horizontal and transverse center line of the lens tube.

33. A method of rotating a lens of a camera, comprising the steps of:
pushing one of two external command buttons mounted on an external casing of a mobile terminal;
if the pushed button is a forward command button, performing the steps of (a) checking a present position of the lens and moving to a standby state for input of an external command when the lens is positioned to face forward at the present time, (b) driving a motor mounted in the mobile terminal clockwise when the lens is positioned to face backward at the present time, (c) sensing at least one projection in the lens tube of the camera by a forward sensor of two sensors arranged at predetermined positions in a camera casing, (d) stopping the motor, and (e) moving to a standby state for input of an external command; and
if the pushed button is a backward command button, performing the steps of (f) checking a present position of the lens and moving to a standby state for input of an external command when the lens is positioned to face backward at the present time, (g) driving a motor mounted in the mobile terminal counterclockwise when the lens is positioned to face forward at the present time, (h) sensing at least one projection in the lens tube of the camera by a backward sensor of two sensors arranged at predetermined positions in the camera casing, (i) stopping the motor, and j) moving to a standby state for input of an external command.

34. The camera lens rotating method according to claim 33, wherein:
the projection is formed so that an arc angle Z of the projection is 2a+b−Rs≦Z≦180−Rs−d, where:
2a is an arc angle of the camera lens;
b is an angle between a rear inner edge of the external casing and a horizontal and transverse center line of the lens tube;
d is an angle between a forward inner edge of the external casing and the horizontal and transverse center line of the lens tube;
Rs is an angle between a rear outer edge of the external casing and the horizontal and transverse center line of the lens tube;
the camera casing has a lens parking button mounted thereon; and
the camera lens rotating method further comprises the steps of driving the motor counterclockwise after a predetermined time Δt if a power off button or the lens parking button is pushed, and stopping the motor when an output value of the sensor is transitioned to low from high.
